(19) United States
(12) Patent Application Publication
(10) Pub. No.: US 2010/0081441 A1
(43) Pub. Date: Apr. 1, 2010

(54) Dynamic Radio Frequency Allocation for Base Station Cooperation with Interference Management

(76) Inventors: Zhifeng Tao, Allston, MA (US); Koon Hoo Teo, Lexington, MA (US); Yu-Jung Chang, Los Angeles, CA (US); Xuehong Mao, Salt Lake City, UT (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/241,889

(22) Filed: Sep. 30, 2008

(51) Int. Cl. H04W 72/00

(52) U.S. Cl. 455/450

(57) ABSTRACT

A method allocates bandwidth from a radio frequency spectrum in a cellular network including a set of cells. Each cell includes a base station for serving a set of mobile stations in the cell. An area around each base station is partitioned into a center region and a boundary region. In each base station, bandwidth for use in the center region is reserved according to an inter-cell interference coordination (ICIC) protocol, and bandwidth for use in the boundary region is reserved according to the ICIC protocol and a base station cooperation (BSC) protocol. Then, the bandwidth is allocated to mobile stations as the mobile stations communicate with the base station in the center regions and the boundary regions according to the bandwidth reservations.

### RELATED APPLICATION

This Application claims priority to U.S. Provisional Patent Application 60/027,112, “Dynamic Radio Resource Allocation for Base Station Cooperation with Interference Management,” filed by Tao et al. on Feb. 8, 2008, incorporated herein by reference.

### FIELD OF THE INVENTION

This invention is generally related to dynamic radio resource allocation in wireless cellular networks, and more particularly to reducing inter-cell interference.

### BACKGROUND OF THE INVENTION

OFDMA

Orthogonal frequency-division multiplexing (OFDM) is a modulation technique used at the physical layer (PHY) of a number of wireless networks, e.g., networks designed according to the well known IEEE 802.11a/g and IEEE 802.16/16e standards. Orthogonal Frequency Division Multiple Access (OFDMA) is a multiple access protocol based on OFDM. In OFDMA, separate sets of orthogonal tones (subchannels or frequencies) and time slots are allocated to multiple transceivers or mobile stations (MS) by a base station (BS) so that the transceivers can communicate concurrently. OFDMA is widely adopted in many next generation cellular networks such as networked based on 3GPP Long Term Evolution (LTE), and IEEE 802.16m standards due to its effectiveness and variability in radio resource allocation.

OFDMA Resource Allocation

Radio frequencies (RF) can carry information by varying a combination of the amplitude, frequency and phase of the wave within a frequency band. The use of the radio spectrum is regulated by many governments through frequency allocation.

As used and defined herein, bandwidth means a portion of the radio frequency spectrum. For example IEEE 802.11a uses bandwidth in the 5 GHz U-NII frequency band, which offers 8 non-overlapping channels, 802.g uses bandwidth in the 2.4 GHz band, like 802.11b, but the same OFDM based transmission scheme as 802.11a. IEEE 802.16a has been amended to 802.16 and uses bandwidth in the 2-11 GHz band for multipoint communication, 802.16e uses scalable OFDMA data, supporting channel bandwidths of between 1.25 MHz and 20 MHz, with up to 2048 sub-carriers, and 802.16m is expected to operate on RF bandwidths of 20 MHz or higher.

Bandwidth and time are the two scarce resources in wireless communications, and therefore an efficient allocation method is needed. The rapid growth of wireless applications and subscriber transceivers, i.e., mobile stations (MS), require a good radio resource management (RRM) method that can increase the network capacity and reduce deployment costs. Consequently, developing an effective radio resource allocation protocol for OFDMA is of significant interest for wireless communication.

The fundamental challenge is to allocate bandwidth of the limited available RF spectrum in a large geographical for a large number of transceivers (also known as users, nodes or terminals). Typically, base stations allocate the resources. In other words, the same frequency spectrum can be used in multiple geographical regions or cells. This will inevitably cause inter-cell interference (ICI), when transceivers or mobile stations (MSs) in adjacent cells use the same spectrum at the same time. In fact, ICI has been shown to be the predominant performance-limiting factor for wireless cellular networks.

To maximize the spectral efficiency, a frequency reuse factor of one is used in OFDMA cell deployment, i.e., the same spectrum is reused by the BS and MS at the same time. Unfortunately, this high spectrum efficiency unavoidably leads to ICI. Therefore, a good ICI management protocol is needed.

For a single cell, most of conventional allocation methods optimize power or throughput under an assumption that each MS uses different subchannels in order to avoid intra-cell interference. That is, all the MS in the cell use disjoint subcarriers for transmitting and receiving signal. Thus, there can be not interference.

Another key assumption in single-cell resource allocation is that the BS has obtained signal-to-noise ratios (SNR) for the subchannels. In a downlink (DL) channel from the BS to the MS, the SNR is normally estimated by the MS and fed back to the BS. In the uplink channel from MS to BS, the BS can estimate the SNR directly based on the signal received from the BS.

In a multi-cell scenario, the signal-to-interference-and-noise ratio (SINR) is difficult to obtain because the interference can come BS and MS in multiple cells and depends on a variety of factors, such as distance, location, and occupied channel status of interferers, which are unknown before resource allocation. This results in mutual dependency of the ICI and complicates the resource allocation problem. Thus, a practical multi-cell resource allocation method that does not require global and perfect knowledge of SINR is desirable.

Inter-Cell Interference Coordination (ICIC)

Inter-cell interference coordination (ICIC) is a protocol that can effectively reduce ICI in regions of the cell relatively far from the BS, i.e., the regions at cell boundaries. ICIC is achieved by allocating disjoint channel resources to the MSs near the boundary of the cell that are associated with different cells. Because boundary MSs are most prone to high ICI, the overall ICI can be substantially reduced by coordination of channel allocation among boundary MSs. More specifically, the ICIC reduces ICI interference by allocating the same resource to MSs that geographically far apart MSs, so that path loss due to the interference is reduced.

However, ICIC solely based on avoiding resource collision for boundary MSs only offers a limited performance gain for DL communications, because it does not consider interference caused by transmission from the BS to MSs in the cell center.

Spatial Division Multiple Access (SDMA)

Space division multiple access (SDMA) provides multi-user channel access by using multiple-input multiple-output (MIMO) techniques with precoding and multi-user scheduling. SDMA exploits spatial information of the location of MSs within the cell. With SDMA, the radiation patterns of the signals are adapted to obtain a highest gain in a particular direction. This is often called beam forming or beam steering. Beam forming is a signal processing technique for directional signal transmission or reception. Beam forming takes advantage of interference to change the directionality of the signal. When transmitting, a beam former controls the phase and relative amplitude of the signal to generate a pattern of constructive and destructive interference. When receiving, information from different antennas is combined in such a way that the expected pattern of radiation is preferentially observed.

BSs that support SDMA transmit signals to multiple mobile stations concurrently using the same resources. SDMA can increase network capacity, because SDMA enables spatial multiplexing. Nevertheless, the ICI still remains a key issue, even if SDMA is used.

Base Station Cooperation (BSC)

Base station cooperation (BSC) allows multiple BSs to transmit signals to a single MS concurrently while sharing the same resource, i.e., time and frequency, using beam forming.

BSC utilizes the SDMA technique for the BSs to send signals to the MS cooperatively. BSC is specifically used for boundary MSs that are within the transmission ranges of multiple BSs. In this case, the interfering signal from another BS now becomes part of a useful signal. Thus, BSC has two advantages, spatial diversity and ICI reduction.

Diversity Set

Typically, each MS registers and communicates with one BS called the anchor or serving BS. However, in some scenarios such as handover, concurrent communication with multiple BSs can take place. A diversity set is defined in the IEEE 802.16e standard to serve this purpose. The diversity set keeps track of the anchor BS and adjacent BSs that are within the communication range of a MS. The information of the diversity set is also maintained and updated at the MS.

Macro Diversity Handover (MDHO)

During macro diversity handover (MDHO), multiple base stations transmit the same signals to one single MS in the handover (HO) region. Macro diversity increases the received signal strength and decreases fading in the HO region. MDHO is used when the MS moves through boundary regions from one cell to another. The transfer is accomplished using downlinks (DLs) from the BSs to the MS, by having the BSs transmit multiple copies of the same information to the MS so that either RF combining or diversity combining can be performed at the MS.

In the uplink (UL) from the MS to the BSs, the transfer is accomplished by having two or more BSs receiving the same signal from the MS in the HO region so that selection diversity can use the ‘best’ uplink. MDHO can reduce the ICI even though the same resources are used for duplicate signal. That is, MDHO wastes resources because the MS uses the resources from more than one cell, which could otherwise be used by other MSs.

### SUMMARY OF THE INVENTION

The embodiments of the invention provide a method for allocating resources in wireless networks that incorporates interference management protocols, i.e., inter-cell interference coordination (ICIC) and base station cooperation (BSC).

The cell area is partitioned into a cell center region and a cell boundary region. The cell center region is near the base station, while the boundary region is far from the base station. The boundary region is further partitioned into a set of sectors, e.g., three. It is assumed that the base station has knowledge of the generally geometry of the area, as well as the location of mobile stations (MS) in the regions.

A minimum bandwidth is reserved for the bandwidth allocation to MSs in the center region and the boundary region of the cell. Therefore, consuming all of the bandwidth is avoided, and the MSs are not unnecessarily denied access. The exact amount of guaranteed bandwidth depends on the actual design and can be adjusted accordingly.

For MSs in the center region, ICIC is used. For MSs in the boundary region, two interference management protocols are supported, ICIC and BSC. A fixed bandwidth is allocated for ICIC and a variable bandwidth for BSC. The variability in the bandwidth of the BSC can adapt to the change in traffic loads, i.e., the number of MS being served. Optionally, the BSC bandwidth can be partially or fully switched to ICIC use if there is such a need.

However, the adaptation in the BSC bandwidth may result in spectrum overlapping in sectors that do not involve in the same BSC, and thus ICI can occur. This effect, however, is minimal in this particular resource allocation protocol due to the sector partitioning of the cell boundary regions that isolates non-BSC cooperating sectors.

### BRIEF DESCRIPTION OF THE DRAWINGS

FIG. 1A is a schematic of a radio resource allocation protocol according the embodiments of the invention;

FIG. 1B is a schematic of ICIC spectrum allocation implemented in adjacent cells according to an embodiment of the invention;

FIG. 1C is a schematic of BSC spectrum allocation implemented in adjacent cells according to an embodiment of the invention;

FIG. 2A is a schematic of bandwidth reuse design according to embodiments of the invention;

FIG. 2B is a schematic of an alternative bandwidth reuse design according to embodiments of the invention;

FIG. 2C is a schematic of an alternative bandwidth reuse design according to embodiments of the invention;

FIG. 3 is schematic of a cellular network with two mobile stations and two base stations for and ICIC scenario according to an embodiment of the invention;

FIG. 4 is a schematic of a cellular network with two mobile stations and two base stations for a BSC protocol according to embodiments of the invention;

FIG. 5 is a schematic of cell partitions according to an embodiment of the invention;

FIG. 6 is a flow diagram of a resource allocation method according to an embodiment of the invention.

### DETAILED DESCRIPTION OF THE PREFERRED EMBODIMENT

Resource Allocation

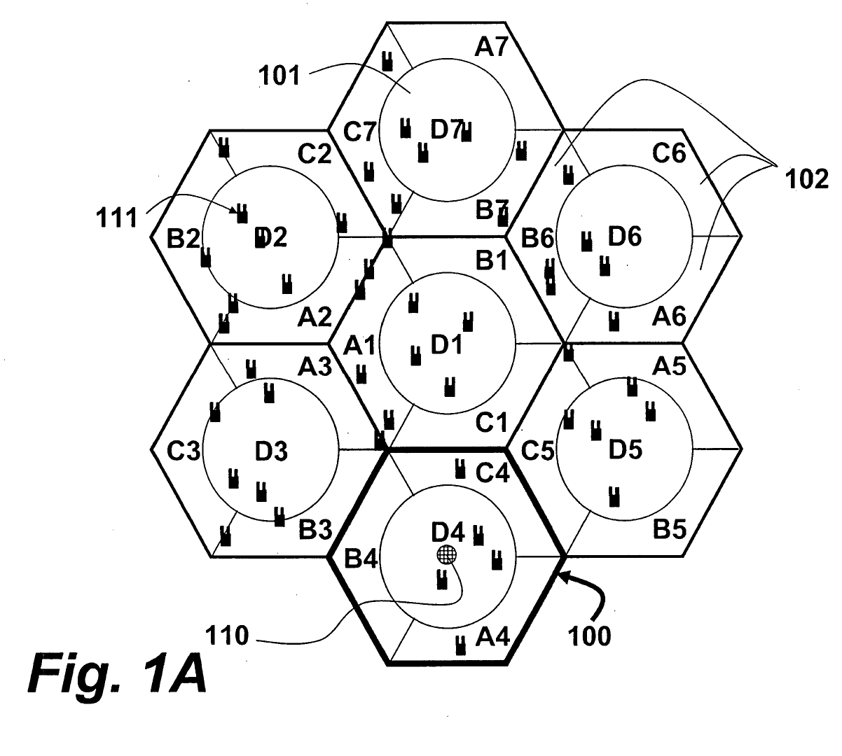

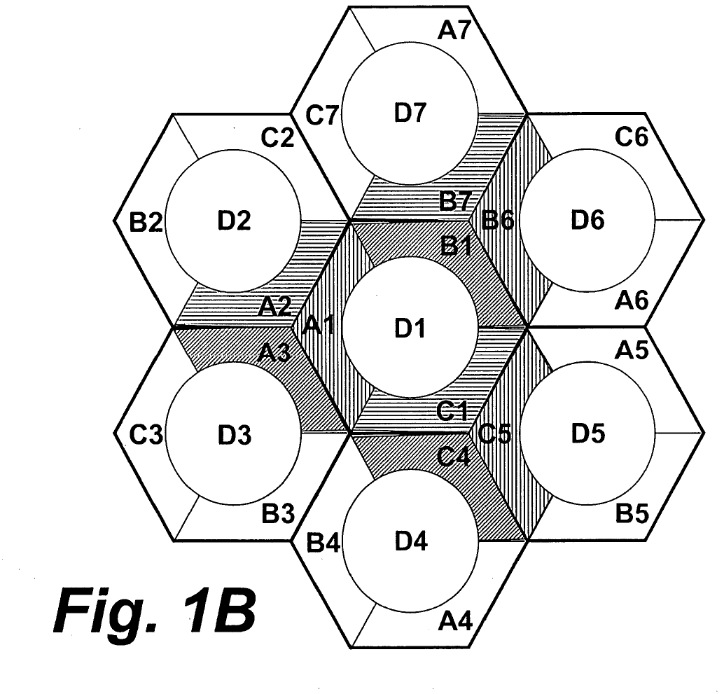

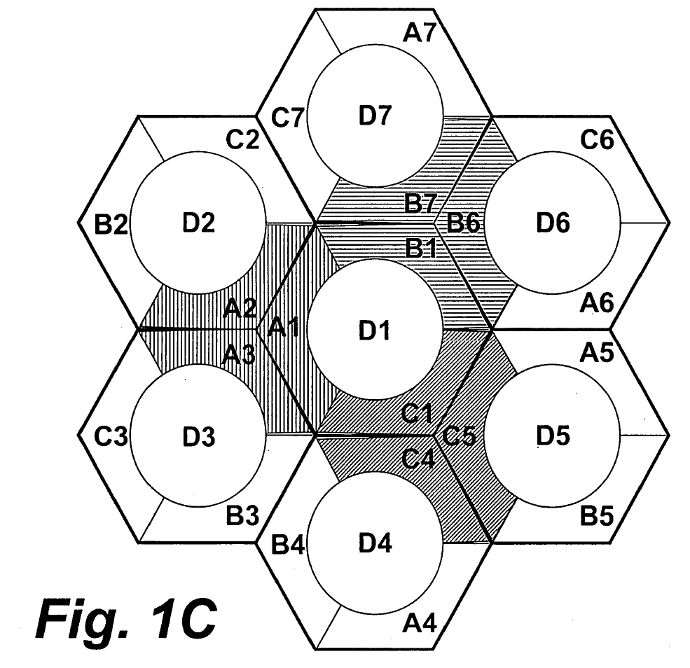

FIG. 1A shows a radio resource allocation structure according to embodiments of our invention. FIG. 1A shows seven cells 100 of a cellular network. To simplify the Figure, the area served in each cell is shown as having a hexagon shape 100. It is understood that this is an approximation of cell shapes, and that other shapes are possible, e.g., depending on geography, topology and structures such as buildings, in the cell.

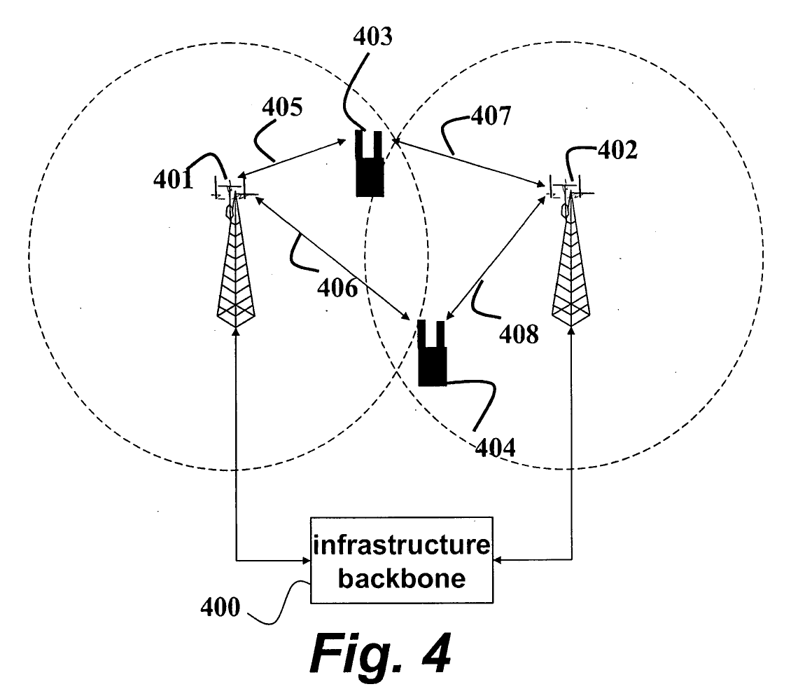

There is a base station 110 at the approximate center of each cell. The base stations serve mobile stations (MS) 111 in the cell. It is understood that the BS can coordinate with each other using an infrastructure 400 or backbone of the network, as known in the prior art and shown in FIG. 4.

The arrangement of FIG. 1A can be generalized to more than seven cells. Here, the frequency reuse factor is one. That is, each cell uses the entire bandwidth allocated for the network. Each cell area is geographically partitioned into a cell center region (D) 101 and cell boundary regions 102, for cells 1 to 7.

As defined herein, the cell area pertains to the entire cell, while the regions are partitions of the area. In the embodiment shown, the cell area is partitioned into a center region and cell boundary regions, e.g., three. However, it should be understood that other partitions are possible. In this description, the various partitions for bandwidth allocation purposes effective apply to the base and mobile stations in the regions.

The cell center region 101 is farther from adjacent cells, and thus, transmissions to mobile stations in the cell center regions cause less inter-cell interference (ICI) to mobile stations in adjacent cells. In contrast, the cell boundary regions 102 abut boundary regions of adjacent cells and thus transmissions to mobile stations in the boundary regions can cause and experience stronger ICI.

In other words, resource allocation (to the mobile stations) in the boundary regions should be more carefully administered so that ICI is reduced. ICI can be reduced by performing planning for the boundary region, in combination with ICI management protocols such as ICIC or base station cooperation (BSC).

Specifically, ICIC is achieved by allocating non-overlapping bandwidth resources to mobile stations in adjacent cell boundary regions, e.g., A1, A2 and A3; or B1, B6 and B7; or C1, C4 and C5. FIG. 1B shows the non-overlapping resources with different hatch markings represent non-overlapping bandwidth allocation.

In comparison, BSC is achieved by allocating the same bandwidth resource to mobile stations that reside in adjacent cell boundary regions and are involved in the same BSC operation. This is shown in FIG. 1C. Note that our radio resource allocation protocol allows the use of both ICIC and BSC management protocols concurrently.

Bandwidth Allocation

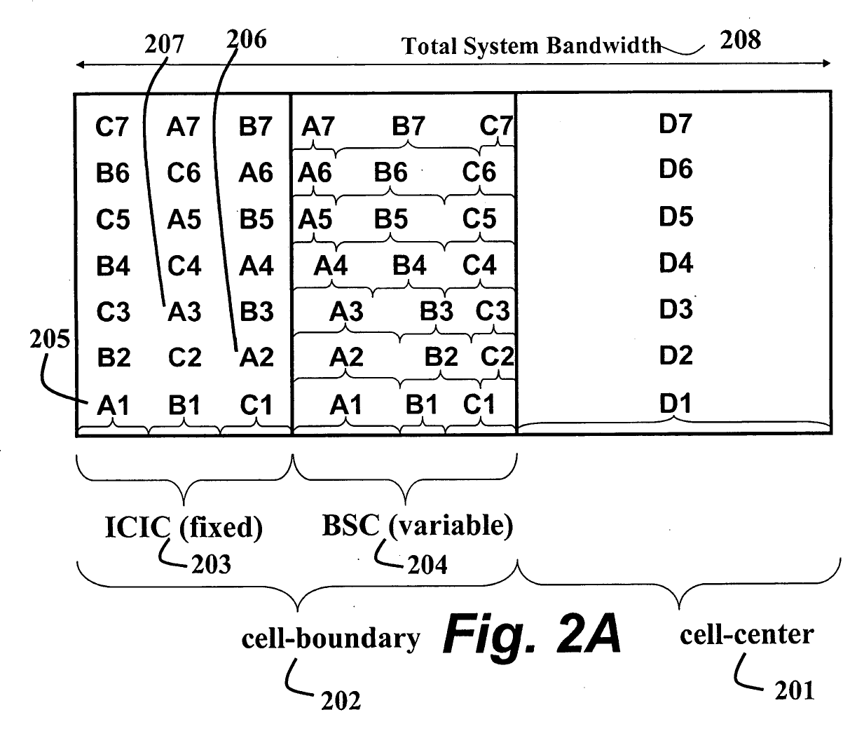

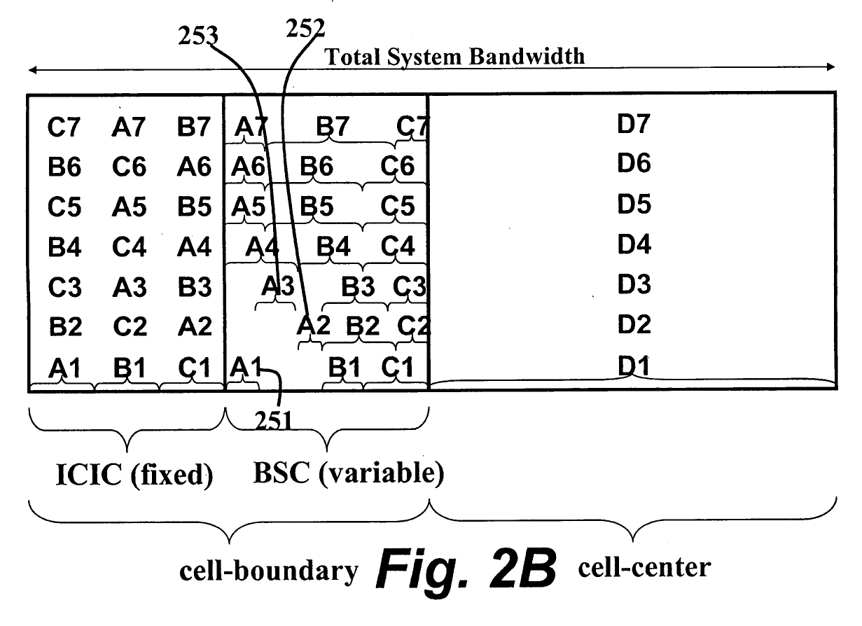

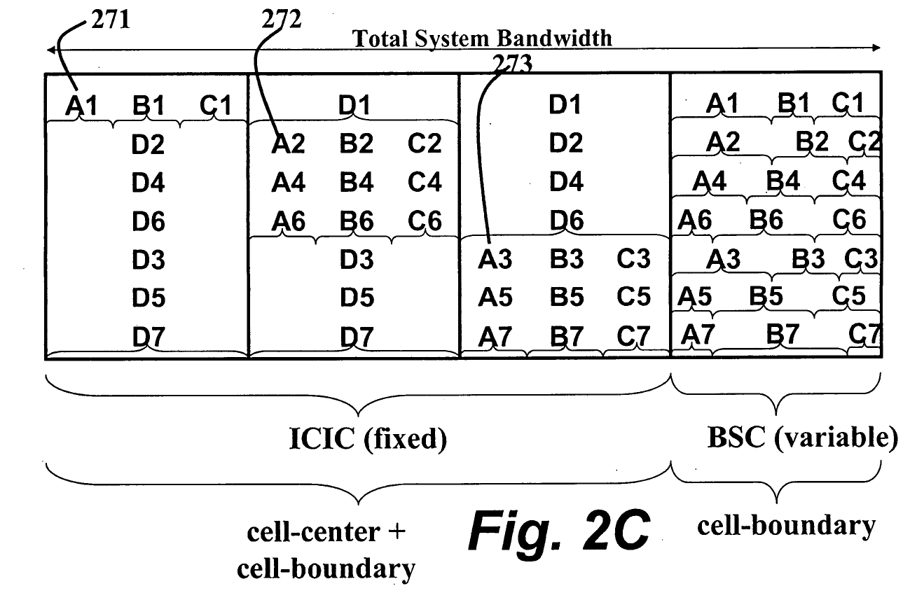

FIGS. 2A-2C show example bandwidth allocation protocols according to embodiments of the invention. As used and defined herein, bandwidth means a portion of the radio frequency spectrum. In these Figures, the horizontal axis indicates available bandwidth, and the vertical axis cell center regions (D) and boundary regions (ABC). It is understood that when we describe bandwidth allocation to regions we mean that reserved bandwidth is allocated to the communications between base and mobile stations in the respective regions.

Initially, during planning the base stations can communicate with each other, determine their geographic relationship, and the various regions. Bandwidth reservations determined during this planning phase can then later be allocated to the mobile stations, as the MSs enter and exit the various regions.

In each cell as shown in FIG. 2A, the entire available network bandwidth is partitioned into two parts: a first part is reserved for mobile stations in cell centers 201, and a second part is reserved for mobile stations in cell boundary regions 202.

The ratio between these two parts depends on the traffic load, and can be adjusted dynamically as the load varies. Here, we show equal bandwidth reservation for the cell boundary and cell center regions, such that the ratio is 1:1. The cell centers uses bandwidth D for all cells. It is assumed that the cell centers are geographically separated, so that ICI is not an issue.

Allocations for mobile stations in cell boundary regions of different cell areas are carefully designed to achieve ICIC or enable BSC, or both.

As shown in FIG. 2A, our bandwidth allocation to cell boundary regions allows the use of both protocols, i.e., ICIC (fixed) 203 and BSC (variable) 204.

In FIG. 2A, the mobile stations in the regions shown in the same column are allocated the same bandwidth. To achieve ICIC 203, the mobile stations in adjacent sectors are allocated disjoint frequency bands to reduce ICI. For instance, regions A1 (205), A2 (206), and A3 (207) are physically contiguous regions, and mobile stations in these regions are allocated disjoint frequency bands; The same holds true for regions B1, B6, B7 and C1, C4, C5.

To achieve BSC 204, the mobile stations in adjacent regions, e.g., A1 205, A2 206, A3 207, are allocated the same bandwidth to enable the BSC protocol.

A size of the allocatable frequency bands can dynamically adapt to the traffic loads in each different region, as shown in FIG. 2A. In the extreme case where there is no traffic load that uses BSC, mobile stations in regions A1 (251), A2 (252) and A3 (253), for instance, can switch from BSC to ICIC without affecting other regions, as shown in FIG. 2B. This variability is highly desirable, as the BSC protocol requires multiple antennas, while ICIC does not. Therefore, in this embodiment, ICIC can be viewed as the primary means for interference management, while BSC is secondary.

FIG. 2C shows another allocation possibility. The difference from FIG. 2A is in the ICIC bandwidth allocation for the cell boundary regions. Specifically, bandwidth is first allocated to cell boundary regions such that any adjacent cells, e.g., cell 1, 2, and 3, have disjoint bandwidths. By doing so, the mobile stations with the strongest interference, e.g., mobile stations in regions A1 271, A2 272, A3 273, communicate on disjoint frequency bands. Then, any residual bandwidth is allocated to (mobile stations in) the cell center region.

ICIC Scenario

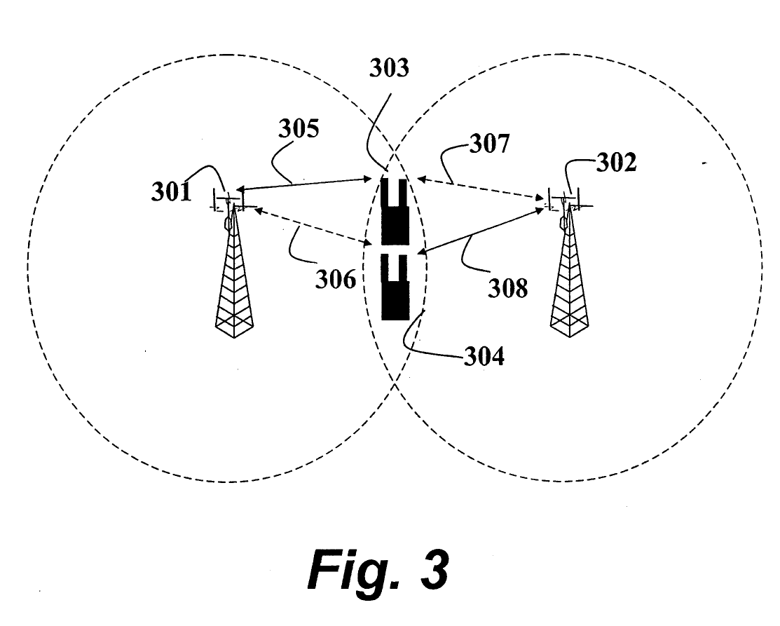

FIG. 3 shows a network for the ICIC scenario with two BSs 301-302 and two MSs 303-304. In FIG. 3, one cell boundary MS 303 is communicating with its BS 301, while the other cell boundary MS 304 is communicating with its BS 302. Due to their proximity, the MSs 303-304 can cause interference 306 and 307 if they concurrently use the same frequency bands. Therefore, the ICIC protocol separates the two interfering signals on different frequency bands so that the interference is be minimized. BSC Scenario

FIG. 4 shows the BSC scenario with two MSs and two BSs. In the non-BSC case, the two cell boundary MSs (403 and 404) communicate individually with their BS (401 and 402, respectively). With BSC, the possibly interfering signals 405-408 are turned into useful signal, thus suppressing ICI, by enabling the MS to communicate with two BSs concurrently.

The 2-MS, 2-BS network shown in FIG. 4 can be operating on the same time and frequency resource as long as the base stations have multiple antennas that can support BSC operation.

Single Cell Partition

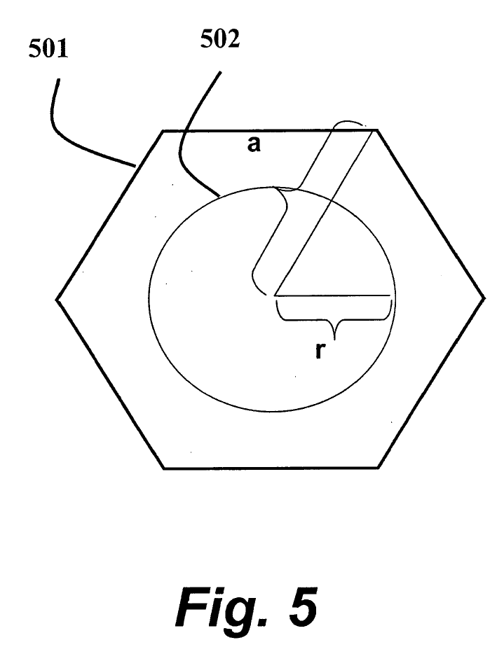

FIG. 5 shows a single cell area 501 and its cell center region 502. A size of the cell center region 502 affects the bandwidth allocation between the cell center region 201 and cell boundary regions 202 as shown in FIG. 2A.

If the MSs are approximately uniformly distributed within a cell, as shown in FIG. 1A, and each mobile station has a similar traffic load, then the bandwidth ratio (BR) of the cell center region 502 to the total network bandwidth is proportional to the ratio of the sizes of the center region 502 to the cell area 501. Some example values of r and a and the resulting BR are listed below in Table A.

TABLE A

| r/a | BR |
|---|---|
| ½ | 0.3023 |
| ⅔ | 0.5374 |
| ¾ | 0.6802 |
| ⅘ | 0.7739 |

The capacity gain for BSC for MS in cell boundary regions increases as r/a increases. FIGS. 2A, 2B and 2C use a BR of 0.5, which corresponds roughly to the case of r/a equal to ⅔.

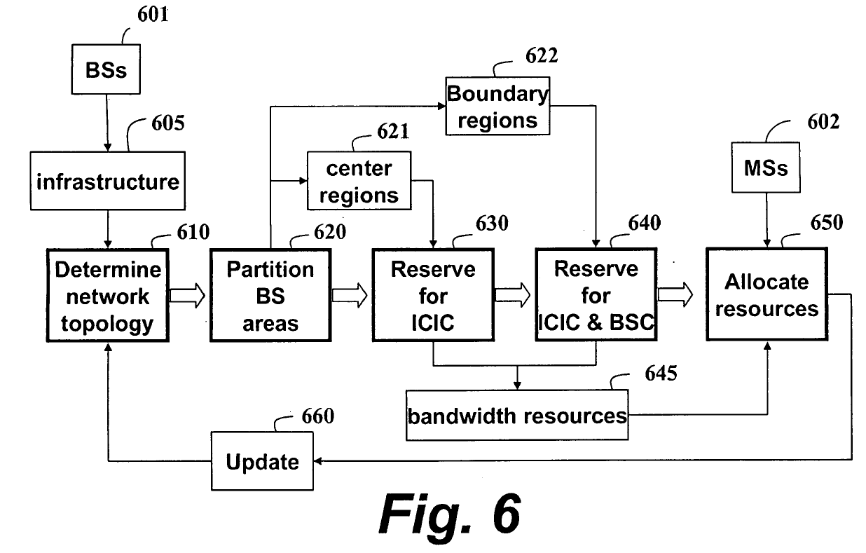

FIG. 6 shows the steps of the general method for reserving and allocating bandwidth in a cellular network.

During a planning phase, the base stations 601 uses the infrastructure 605 to determine a topology of the network.

The topology is partitioned 620 into an area for each base station, and each area is further partitioned into a center region 621 and a boundary region 622. The boundary can be further partitioned into a set of sectors.

Bandwidth for each center region is reserved 630 for use according to the ICIC protocol, while the boundary region reserves 640 bandwidth for use according to the ICIC and BSC protocol. The bandwidth reserved for ICIC is fixed, while the bandwidth reserved for BSC is variable.

After the bandwidth resources 645 have been reserved, they can be allocated to mobile stations 602 as they enter the various regions of the network. The reserved resources 645 can be updated dynamically 660 and reallocated to adapt to changing traffic load and network topology.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for allocating bandwidth from a radio frequency spectrum in a cellular network including a set of cells, wherein each cell includes a base station for serving a set of mobile stations in the cell, comprising:
partitioning an area around each base station into a center region and a boundary region;
reserving, in each base station, bandwidth for allocation in the center region according to an inter-cell interference coordination (ICIC) protocol;
reserving, in each base station, bandwidth for allocation in the boundary region according to the ICIC protocol and a base station cooperation (BSC) protocol; and
allocating the reserved bandwidth to the mobile stations as the mobile stations in the center regions and the boundary regions communicate with the base stations according.

2. The method of claim 1, wherein the partitioning uses an infrastructure of the network.

3. The method of claim 1, wherein the bandwidth reserved for the center region and the bandwidth reserved for boundary region are disjoint.

4. The method of claim 1, wherein the bandwidth for the ICIC protocol in the boundary region and the bandwidth for the BSC protocol in the boundary region of the same cell are disjoint.

5. The method of claim 1, wherein the bandwidth reserved for center region of a particular cell and the bandwidth reserved the boundary of an adjacent cell are disjoint.

6. The method of claim 1, wherein the bandwidth reserved for the ICIC protocol in the center region of a particular cell and the bandwidth reserved for the ICIC protocol in the boundary region of an adjacent cell overlap.

7. The method of claim 1, wherein the bandwidth reserved for the BSC protocol in the boundary region is also used for the ICIC protocol.

8. The method of claim 1, further comprising:
partitioning each boundary region into a set of sectors, and further comprising:
reserving and allocating disjoint bandwidth for adjacent boundary regions in different cells when the mobile stations use the ICIC protocol; and
reserving and allocating the same bandwidth for adjacent boundary regions in different cells when the mobile stations use the BSC protocol.

9. The method of claim 8 wherein the bandwidth reserved for the center region of a particular cell and the bandwidth reserved for the set of sectors of the same cell are disjoint.

10. The method of claim 8, wherein the bandwidth reserved for the ICIC protocol for the set of sectors and the bandwidth reserved for BSC protocol for the set of sectors of the same cell are disjoint.

11. The method of claim 8, wherein the bandwidth reserved for the center region and the bandwidth reserved for the set of sectors in the boundary region of an adjacent cells are disjoint.

12. The method of claim 8, wherein the bandwidth reserved for the ICIC protocol in the center region and the bandwidth reserved for the ICIC protocol in the boundary region of an adjacent cells overlap.

13. The method of claim 8, wherein the bandwidth reserved for the BSC protocol for the set of sectors in the boundary region are also used for the ICIC protocol.

14. The method of claim 1, wherein the bandwidth reserved for the ICIC protocol is fixed, and the bandwidth reserved for the BSC protocol is variable.

15. The method of claim 1, wherein a ratio of the bandwidth reserved for the center region and the boundary region depends on a traffic load.

16. The method of claim 1, wherein the ratio is adjusted dynamically as the traffic load varies.

17. The method of claim 1, wherein the ratio depends on sizes of the center region and the boundary region.

18. The method of claim 1, wherein the mobile stations are mobile between the center regions and the boundary regions of the set of cells, and the allocating is dynamically updated
